(19) United States
(12) Patent Application Publication
(10) Pub. No.: US 2007/0285703 A1
(43) Pub. Date: Dec. 13, 2007

(54) Image Forming Apparatus

(75) Inventor: Toshihiro Ida, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/423,401

(22) Filed: Jun. 9, 2006

(51) Int. Cl. G06F 3/12

(52) U.S. Cl. 358/1.15

(57) ABSTRACT

An image forming apparatus includes a code acquiring unit configured to acquire a code, an identification code storing unit configured to store an identification code for performing specific processing, an identification code judging unit configured to, when a code is acquired by the code acquiring unit, judge whether the code is an identification code stored in the identification code storing unit, and an executing unit configured to execute specific processing corresponding to the acquired identification code on the basis of the judgment by the identification code judging unit.

### BACKGROUND OF THE INVENTION

1. Field of the Invention

This invention relates to an image forming apparatus.

2. Description of the Related Art

A print server is known that receives print information from plural terminal devices, stores the print information and temporarily saves a print enabling code associated with the print information. In this print server, when an identification code is subsequently inputted at a collating unit, it is judged whether there is an identification code that coincides with the inputted identification code. Then, if there is a coincident identification code, the printer server retrieves the print information corresponding to the identification code and sends the print information to a printer. Then, the printer carries out printing based on the print information sent thereto.

In the foregoing technique, only the print processing for the print information corresponding to the identification code is carried out as a method of utilizing the identification code inputted at the collating unit. Therefore, special operations such as those carried out by the manager of the print server or printer cannot be carried out.

### BRIEF SUMMARY OF THE INVENTION

It is an object of this invention to provide an image forming apparatus that can perform a special operation by using an identification code.

According to an aspect of this invention, an image forming apparatus includes a code acquiring unit configured to acquire a code, an identification code storing unit configured to store an identification code for performing specific processing, an identification code judging unit configured to, when a code is acquired by the code acquiring unit, judge whether the code is an identification code stored in the identification code storing unit, and an executing unit configured to execute specific processing corresponding to the acquired identification code on the basis of the judgment by the identification code judging unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view schematically showing a network configuration in a first embodiment of this invention

FIG. 2 is a view showing a personal card in the embodiment.

FIG. 3 is a view showing a maintenance mode starting card in the embodiment.

FIG. 4 is a view showing a print waiting file deleting card in the embodiment.

FIG. 5 is a block diagram schematically showing the configuration of essential parts of an image forming apparatus in the embodiment.

FIG. 6 is a table showing the correspondence between personal identification code and personal name in the embodiment.

FIG. 7 is a table showing the correspondence between identification code and specific function in the embodiment.

FIG. 8 is a flowchart showing essential parts of specific function execution processing in the embodiment.

FIG. 9 is a table showing the correspondence between identification code and specific function in a second embodiment of this invention.

FIG. 10 is a flowchart showing essential parts of specific function execution processing in the embodiment.

FIG. 11 is a flowchart showing essential parts of code saving processing in the embodiment.

### DETAILED DESCRIPTION OF THE INVENTION

Hereinafter, each embodiment of this invention will be described with reference to the drawings.

### First Embodiment

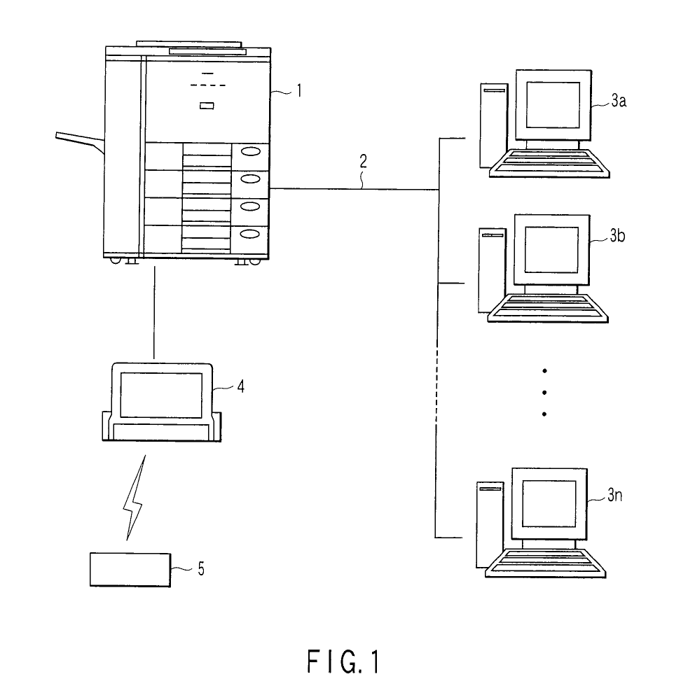

FIG. 1 is a view schematically showing a network configuration in a first embodiment of this invention. A multifunction peripheral (MFP) 1 is connected to plural terminal devices (for example, PCs) 3a, 3b, . . . , 3n via a network 2. Also, a card reader 4 is connected to the MFP 1. This card reader 4 can read a code in a non-contact manner from a card 5 in which the code is stored.

Next, the card 5 read by the card reader 4 will be described. A personal card 5a, a maintenance mode starting card 5b and a print file deleting card 5c will be described as examples of the card 5 to be read.

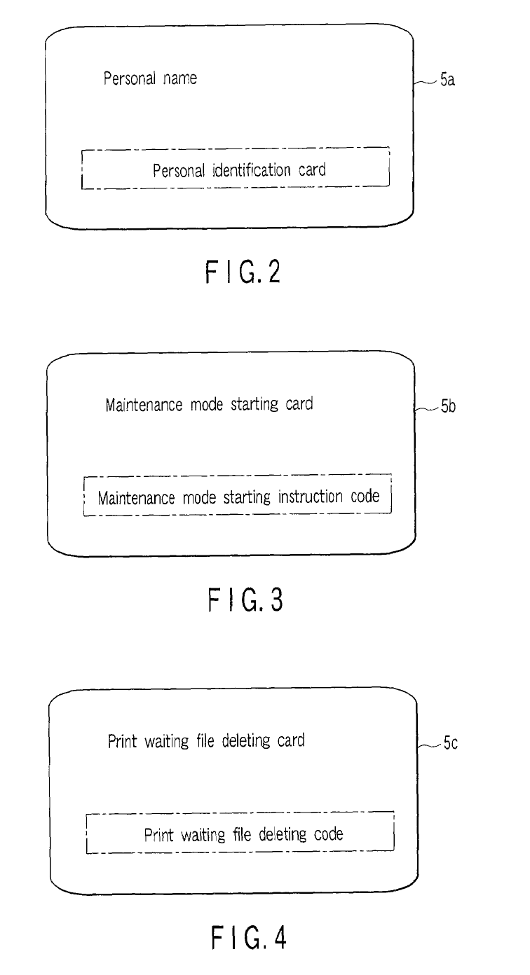

FIG. 2 shows the personal card 5a for specifying an individual who is the user of each terminal device 3a, 3b, . . . , 3n. In this card 5a, a personal identification code for specifying an individual is stored. The personal identification code may not only identify an individual but also identify a group.

FIG. 3 shows the maintenance mode starting card 5b. In this card 5b, a maintenance mode starting code for giving an instruction to start the MFP 1 in a maintenance mode is stored. The maintenance mode is a mode in which the MFP 1 is started by a serviceman when carrying out maintenance such as maintenance service of the MFP 1. Therefore, the maintenance mode starting card 5b is a card held by the serviceman.

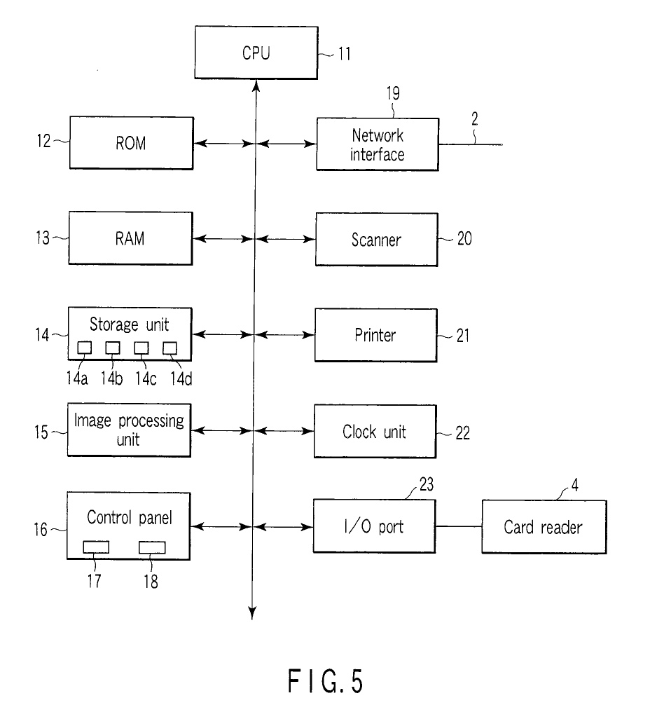

FIG. 4 is a view showing the print waiting file deleting card 5c. In this card 5c, a print waiting file deleting code for deleting a print waiting file is stored.

FIG. 5 is a block diagram showing the configuration of essential parts of the MFP 1. As shown in FIG. 5, the MFP 1 includes a CPU 11, ROM 12, RAM 13, storage unit 14, image processing unit 15, control panel 16, network interface 19, scanner 20, printer 21, clock unit 22 and I/O 23. The CPU 11 is connected with the ROM 12, RAM 13, storage unit 14, image processing unit 15, control panel 16, network interface 19, scanner 20, printer 21, clock unit 22 and I/O 23 via a bus line.

The CPU 11 executes a control program stored in the ROM 12 and the storage unit 14, thereby controlling the whole MFP 1. The ROM 12 stores the control program to be executed by the CPU 11 and fixed data. The RAM 13 has a work area or the like required when the CPU 11 executes the control program stored in the ROM 12.

The storage unit 14 is, for example, a hard disk drive, The storage unit 14 has a control program storing unit 14a, a print file saving unit 14b, a storing unit 14c for storing a personal identification code table T1, a storing unit 14d for storing a specific function table T2, and the like.

The storing unit 14a stores a control program such as a control program for performing specific function execution processing, which will be described later. The print file saving unit 14b saves a print file to which a personal identification code and a print enabling code transmitted from each terminal device 3a, 3b, . . . , 3n have been attached.

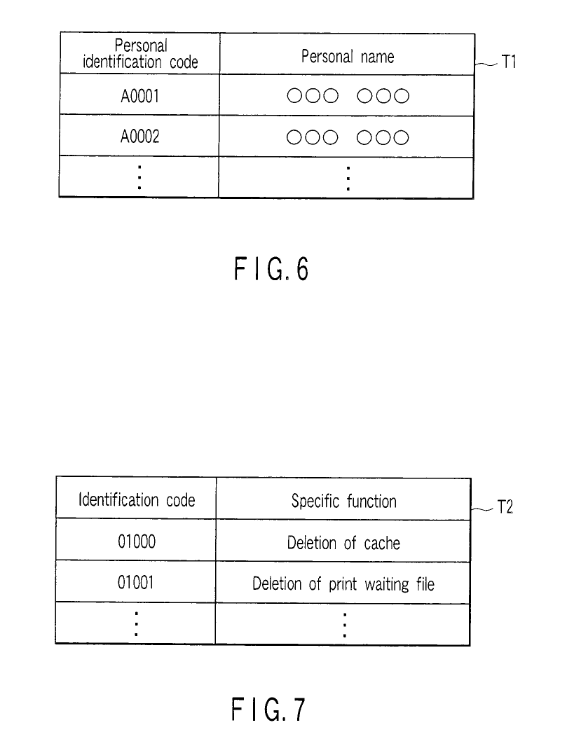

The personal identification table T1 stored in the storing unit 14c is a table showing the correspondence between personal identification code and individual, FIG. 6 shows the personal identification table T1. As shown in FIG. 6, in the table T1, personal names of the respective terminal devices 3a, 3b, . . . , 3n are stored corresponding to personal identification codes (A0001, A0002, . . . ).

The specific function table T2 stored in the storing unit 14d is a table showing the correspondence between identification code and specific function. FIG. 7 shows the specific function table T2. As shown in FIG. 7, in the table T2, specific functions (start of maintenance mode, deletion of print waiting file) are stored corresponding to identification codes (01000, 01001).

The image processing unit 15 performs processing such as compression and decompression of image data. The control panel 16 has an operating unit 17 and a display unit 18. The operating unit 17 transmits an instruction received from a user, to the CPU 11. The display unit 18 displays information necessary for the user, under the control of the CPU 11.

The network interface 19 is connected with the network 2 and performs data communication such as receiving a print file from each terminal device 3a, 3b, . . . , 3n connected to the network 2. The scanner 20 reads an image from a manuscript set on a manuscript table, not shown, or a manuscript sent thereto by an automatic paper feeder, not shown, and generates image data. The printer 21 forms an image onto a paper on the basis of a print waiting file or the like received via the network 2.

The clock unit 22 generates date and time information. The date and time information generated by the clock unit 22 is acquired by the CPU 11, when necessary. The I/O 23 is connected with the card reader 4. The I/O 23 transmits the recognition of a card by the card reader 4 and a code that is read from the card in a non-contact manner, to the CPU 11.

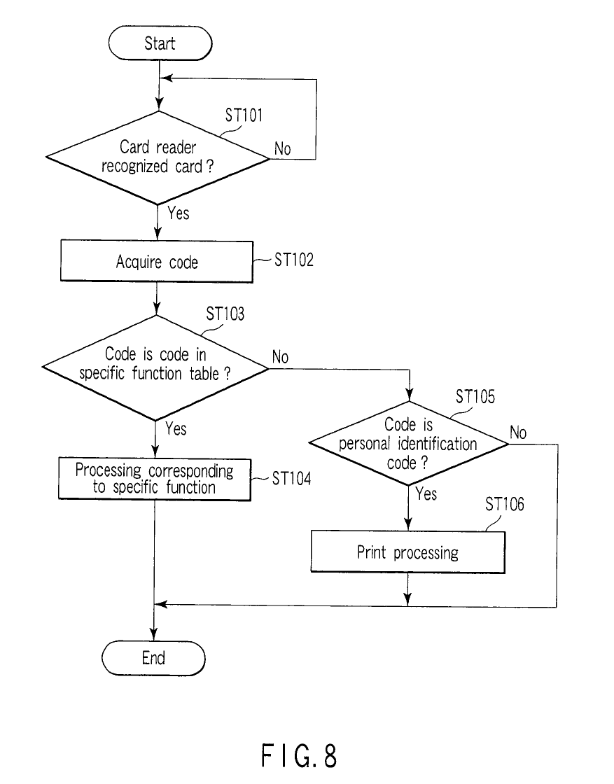

Next, the specific function execution processing will be described. FIG. 8 is a flowchart showing essential parts of the specific function execution processing executed by the CPU 11.

The CPU 11 judges whether the card reader 4 recognized the card 5 or not (ST101). If it is judged that the card reader 4 recognized the card 5 (YES at ST101), the CPU 11 acquires a code read from the card 5 by the card reader 4 (ST102).

The CPU 11 judges whether the acquired code is a code stored in the specific function table T2 or not (ST103). If it is judged that the code is a code stored in the specific function table T2, that is, an identification code (YES at ST103), the CPU 11 executes processing that corresponds to a specific function corresponding to the identification code (ST104). For example, if the identification code is a maintenance mode starting instruction code, the maintenance mode is started. For example, if the identification code is a print waiting file deleting code, a print waiting file stored in the print file storing unit 14b is deleted.

Meanwhile, if it is judged that the code is not a code stored in the specific function table T2 (NO at ST103), the CPU 11 judges whether the code is a personal identification code or not (ST105). If it is judged that the code is a personal identification code (YES at ST105), the CPU 11 executes printing of a print file to which the personal identification code has been attached, of print files saved in the print file saving unit 14b (ST106). If it is judged that the code is not a personal identification code (NO at ST105), the CPU 11 ends the processing.

According to this embodiment, for example, when the manager of the MFP 1 wants to start the MFP 1 in the maintenance mode, the manager can simply hold the maintenance mode starting card 5a over the card reader 4, thereby starting the MFP 1 in the maintenance mode. Therefore, when starting the MFP 1 in the maintenance mode, the manager need not carry out any special operation and it is very convenient for the manager. Also, in the case where many print files are still stored in the print file storing unit 14b without being printed, the user can simply hold the print waiting file deleting card 5c over the card reader 4, thereby deleting all the print files. Thus, the time and labor for deleting the print files can be reduced.

### Second Embodiment

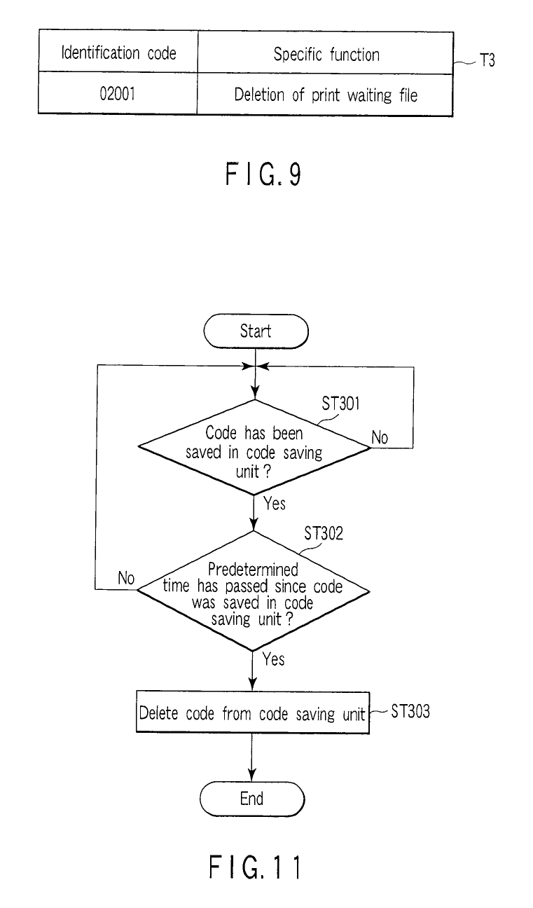

Next, a second embodiment will be described. The same parts as in the above-described embodiment are denoted by the same numerals and will not be described further in detail. In this second embodiment, a specific function card and a personal identification card are combined to cause the MFP 1 to execute predetermined processing, In this second embodiment, along with the above-described personal identification table T1, a specific function table T3 shown in FIG. 9 is provided instead of the above-described specific function table T2 in the storage unit 14. In the specific function table T3, only a print waiting file deleting instruction code that instructs deletion of a print waiting file is stored. In this second embodiment, the case is described where only a print waiting file deleting instruction code is stored in the specific function table T3, but the table is not limited to this.

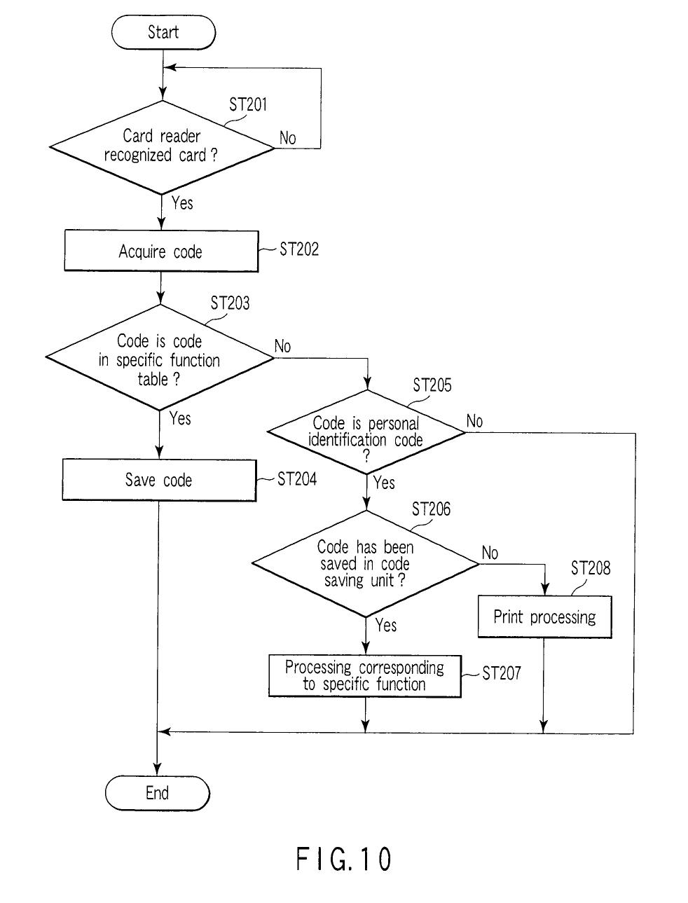

The specific function execution processing will be described next. FIG. 10 is a flowchart showing the specific function execution processing executed by the CPU 11. The processing of steps ST201 to ST203 is similar to the above-described steps ST101 to ST103, respectively, and therefore will not be described further in detail.

If the CPU 11 judges that the code is the code stored in the specific function table T3, that is, an identification code (YES at ST203), the CPU 11 saves the code into the RAM 13. This code is stored into a code saving unit (not shown) within the RAM 13. Then, the processing ends.

On the other hand, if the CPU 11 judges that the code is not the code stored in the specific function table T3 (NO at ST203), the CPU 11 then judges whether the code is a personal identification code or not (ST205). If it is judged that the code is a personal identification code (YES at ST205), the CPU 11 judges whether the code has been saved in the code saving unit of the RAM 13 or not (ST206),

If it is judged that the code has been saved in the code saving unit of the RAM 13 (YES at ST206), processing corresponding to the saved code is executed to a print file specified by the personal identification code (ST207). That is, only a print file containing the acquired personal identification code is deleted, of the print files stored in the specific print file storing unit 14b.

If it is judged that the code has not been saved in the code saving unit of the RAM 13 (NO at ST206), the print file containing the acquired personal identification code is printed, of the print files stored in the specific print file storing unit 14b (ST208).

The CPU 11 ends the processing if it judges that the code is not a personal identification code (NO at ST205), or if it the processing corresponding to the specific function is executed (ST207), or if the print processing is executed (ST208).

Next, the handling of the code saved in the code saving unit of the RAM 13 will be described. FIG. 11 is a flowchart showing code deletion processing executed by the CPU 11.

The CPU 11 judges whether the code has been saved in the code saving unit of the RAM 13 or not (ST301). If it is judged that the code has been saved in the code saving unit (YES at ST301), the CPU 11 judges whether or not a predetermined time, for example, three seconds, has passed since the code was saved to the code saving unit (ST302). If it is judged that the predetermined time has not passed (NO at ST302), the processing returns to step ST301.

On the other hand, if it is judged that the predetermined time has passed (YES at ST303), the code saved in the code saving unit of the RAM 13 is deleted (ST303). Then, the processing ends.

According to this embodiment, when the user wants to delete a print file stored in the MFP 1, the user can simply perform an operation of holding the user's own personal identification card 5a over the card reader 4 within a predetermined time after holding the print waiting file deleting card 5c over the card reader 4, thereby deleting only the print file sent by the user, of the print files stored in the MFP 1.

Moreover, a print file will not be deleted immediately even if the print waiting file deleting card 5c is recognized by the card reader 4. Unless the personal identification card 5a is recognized after the card 5c is recognized, the print file corresponding to the personal identification card 5a will not be deleted. Therefore, unexpected deletion of the print file can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a code acquiring unit configured to acquire a code;
an identification code storing unit configured to store an identification code for performing specific processing;
an identification code judging unit configured to, when a code is acquired by the code acquiring unit, judge whether the code is an identification code stored in the identification code storing unit; and
an executing unit configured to execute specific processing corresponding to the acquired identification code on the basis of the judgment by the identification code judging unit.

2. The image forming apparatus according to claim 1, wherein the executing unit executes the specific processing if the judging unit judges that the acquired identification code has been stored in the identification code storing unit.

3. The image forming apparatus according to claim 2, wherein the specific processing is processing to delete all print waiting files.

4. The image forming apparatus according to claim 2, wherein the specific processing is processing to start a maintenance mode.

5. The image forming apparatus according to claim 1, comprising:
an identification code saving unit configured to save the acquired identification code if the identification code judging unit judges that the acquired identification code has been stored in the identification code storing unit;
a personal identification code storing unit configured to store the personal identification code;
a print waiting file saving unit configured to save a print waiting file to which a personal identification code has been appended;
a personal identification code judging unit configured to, when a code is acquired by the code acquiring unit, judge whether the acquired code is a code stored in the personal identification code storing unit; and
a code saving judging unit configured to, when the personal identification code judging unit judges that the code is a personal identification code, judge whether the identification code has been saved in the code saving unit;
wherein when the code saving judging unit judges that the identification code has been saved, the executing unit executes specific processing to a print waiting file specified by the acquired personal identification code, of print waiting files saved in the print waiting file saving unit.

6. The image forming apparatus according to claim 5, wherein the specific processing is processing to delete a print waiting file,

7. The image forming apparatus according to claim 6, wherein when the code saving judging unit judges that the identification code has not been saved, the executing unit executes print processing to a print waiting file specified by the acquired personal identification code, of print waiting files saved in the print waiting file saving unit.

8. An image forming apparatus comprising:
code acquiring means for acquiring a code;
identification code storing means for storing an identification code for performing specific processing;
identification code judging means for, when a code is acquired by the code acquiring means, judging whether the code is an identification code stored in the identification code storing means; and
executing means for executing specific processing corresponding to the acquired identification code on the basis of the judgment by the identification code judging means.

9. The image forming apparatus according to claim 8, wherein the executing means executes the specific processing if the identification code judging means judges that the acquired identification code has been stored in the identification code storing means.

10. The image forming apparatus according to claim 9, wherein the specific processing is processing to delete all print waiting files.

11. The image forming apparatus according to claim 9, wherein the specific processing is processing to start a maintenance mode.

12. The image forming apparatus according to claim 8, comprising:
identification code saving means for saving the acquired identification code if the identification code judging means judges that the acquired identification code has been stored in the identification code storing means;
personal identification code storing means for storing the personal identification code;
print waiting file saving means for saving a print waiting file to which a personal identification code has been appended;
personal identification code judging means for, when a code is acquired by the code acquiring means, judging whether the acquired code is a code stored in the personal identification code storing means; and
code saving judging means for, when the personal identification code judging means judges that the code is a personal identification code, judging whether the identification code has been saved in the code saving means;
wherein when the code saving judging means judges that the identification code has been saved, the executing means executes specific processing to a print waiting file specified by the acquired personal identification code, of print waiting files saved in the print waiting file saving means.

13. The image forming apparatus according to claim 12, wherein the specific processing is processing to delete a print waiting file.

14. The image forming apparatus according to claim 13, wherein when the code saving judging means judges that the identification code has not been saved, the executing means executes print processing to a print waiting file specified by the acquired personal identification code, of print waiting files saved in the print waiting file saving means.

15. A method for executing processing of an image forming apparatus, comprising:
acquiring a code;
judging whether the acquired code is an identification code for performing specific processing; and
executing specific processing corresponding to the acquired identification code on the basis of the judgment.

16. The method according to claim 15, wherein the executing step includes executing the specific processing if it is judged that the acquired code is the identification code.

17. The method according to claim 15, wherein the specific processing is processing to delete all print waiting files.

18. The method according to claim 9, wherein the specific processing is processing to start a maintenance mode.

19. The method according to claim 15, comprising:
if it is judged that the acquired code is the identification code, saving the acquired identification code;
when a code is acquired, judging whether the acquired code is a personal identification code; and
when it is judged that the code is the personal identification code, judging whether the identification code has been saved;
wherein the executing step includes, if it is judged that the identification code has been saved, executing specific processing to a print waiting file specified by the acquired personal identification code, of print waiting files saved in a print waiting file saving unit that saves print waiting files to which a personal identification code has been appended.

20. The method according to claim 19, wherein the specific processing is processing to delete a print waiting file.
